(19) United States
(12) Patent Application Publication
(10) Pub. No.: US 2005/0103576 A1
(43) Pub. Date: May 19, 2005

(54) Method and device for a lift

(75) Inventor: Roland Engstrom, Skelleftea (SE)

Correspondence Address: NIXON & VANDERHYE, PC, 1100 N GLEBE ROAD, 8TH FLOOR, ARLINGTON, VA, 22201-4714, US

(73) Assignee: ALIMAK AB, Skelleftea (SE)

(21) Appl. No.: 10/974,010

(22) Filed: Oct. 27, 2004

(30) Foreign Application Priority Data
Oct. 30, 2003 (SE) 0302859-4

(51) Int. Cl. B66B 5/04; B66B 1/02

(52) U.S. Cl. 187/287; 187/305; 187/307

(57) ABSTRACT

A method of lowering a lift cage is provided for a motorised lift that has a device for releasing a motor brake included in a drive motor, an actuator operated from the lift cage that from its initial position can drive the brake release mechanism to an active brake release position and back to its initial position, and a catching device that stops the lift cage in case its descent should exceed a predetermined speed limit. For efficient regulation and control of the lowering speed the actuator is arranged to respond to a periodically repeated measure by being moved in a previously defined operating cycle controlled by a signal processing system to an active brake releasing position and then back again to its initial position, and the time it takes for the operating movement of the actuator within the operating cycle can be adapted to the downward acceleration of the lift cage when the motor brakes are released so that it has time to return to its original position before the lift cage has exceeded the predetermined speed limit.

The present invention concerns a method of lowering a lift cage on a motor driven lift according to the preamble to claim 1. The invention also concerns a device for carrying out the method according to the preamble to claim 5.

For reasons of safety, the drive motor in lift equipment for the vertical movement of persons or goods and similar arrangements must be equipped with some type of motor brake designed to be in an active braking position with the rotating motor shaft in the absence of drive voltage or the occurrence of overloading. To offer said braking action, this type of motor has a means of braking which, mounted on one end of the motor, can be put into a braking interaction with the rotating motor shaft. In addition to the motor brake, there is normally also a requirement for the lift to be equipped with some type of catching device that is to come into force if the lift cage should exceed a predetermined speed limit, for example if the lift cage should drop uncontrollably. Such catching devices are already well-known and usually comprise a first and a second brake element arranged to provide a relative braking friction grip and a means of engagement that can drive the brake elements to grip each other in case the lift cage should exceed the aforesaid speed limit.

For the evacuation of passengers inside the lift cage in case of emergencies and the absence of motor drive voltage, the lift is equipped with a control allowing the motor brake to be released manually and in this way lower the lift cage to a suitable evacuation floor. The said control is normally arranged in conjunction with the lift drive machinery but where appropriate can be located in a suitable position inside the lift cage itself or in conjunction with the same so that the control is accessible from inside the lift cage.

The problem however is that if the lift cage drops too rapidly after releasing the brakes it can activate the catching device and consequently lock the lift in a disadvantageous position. Even if personnel have been trained to manage an evacuation in such an emergency situation, there is still an obvious risk that the lift cage can be lowered too rapidly, activating the catching device and jamming the lift cage. In particular, this could happen in any genuinely critical situation such as a fire or similar circumstances and when there is a risk that even the most well-trained person may panic.

Devices for manually lowering a lift cage are already known and, for example, in U.S. Pat. No. 6,273,216 a lowering device is described comprising a first means of releasing the motor brake controlled from inside the lift cage and a second means controlled from inside the lift cage with which the lift can be cranked to a suitable level. This second means of control includes an engageable rack and pinion mechanism with associated crank handle. Because the lift is cranked manually at a very high gear ratio and therefore relatively low speed, there is no immediate risk of the catching device being activated. One disadvantage of this type of an emergency lowering device is partly that in an extreme emergency situation it is considered too slow to handle the demands on rapid lowering that are present, and partly it requires an especially engageable drive mechanism, making it expensive and complicated.

There are often demands that the passengers in the lift cage must quickly and independently be able to save themselves in an emergency situation, particularly on the kinds of lift applications that are intended to be used in more demanding environments. One example of a lift installation where such a requirement is especially noticeable is on lifts used on oil platforms and in similar operations where there is a high risk of fire and explosion.

One object of the present invention is therefore to achieve a method and a device for a lift that makes it possible in a manual and efficient way to lower the lift cage to a suitable level for evacuation without activating the catching device. In particular in this connection it is sought to achieve a device that is both cheap to manufacture and possible to install on existing lift installations.

This object of the invention can be achieved with a device exhibiting the distinctive features and characteristics specified in claim 1.

An embodiment of the invention will be described in more detail in the following with references made to the attached drawings, of which:

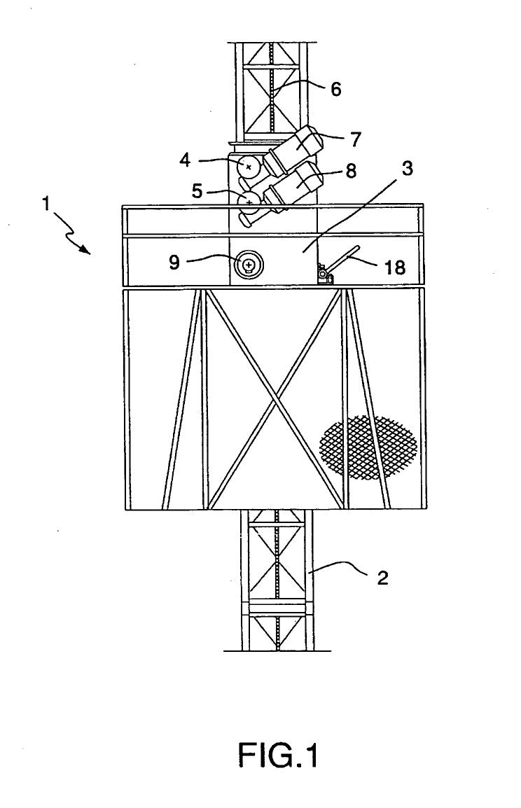

FIG. 1 shows the side view of a lift of the kind on which the invention can be applied,

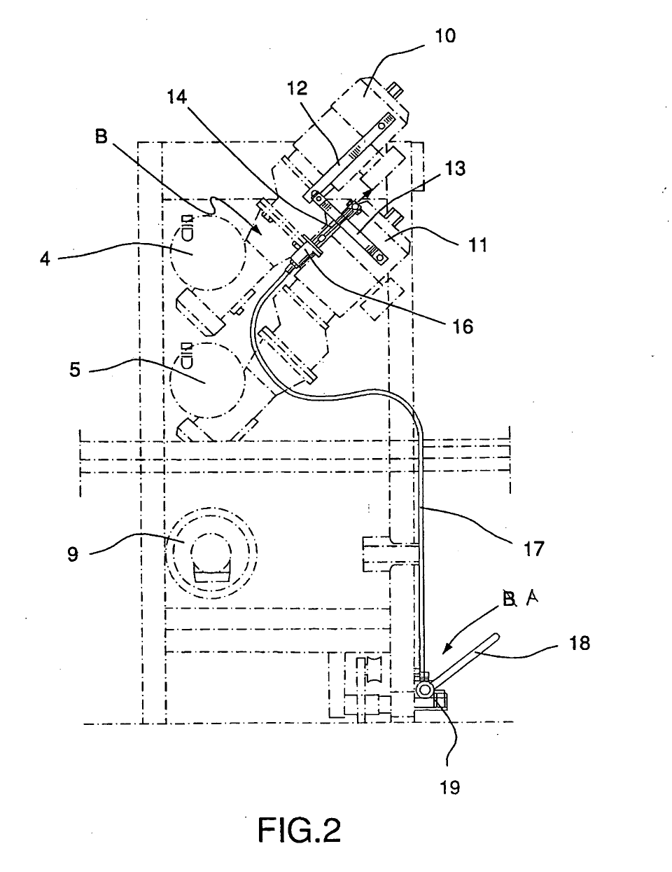

FIG. 2 shows in larger scale the emergency lowering device according to the invention that is shown in FIG. 1.

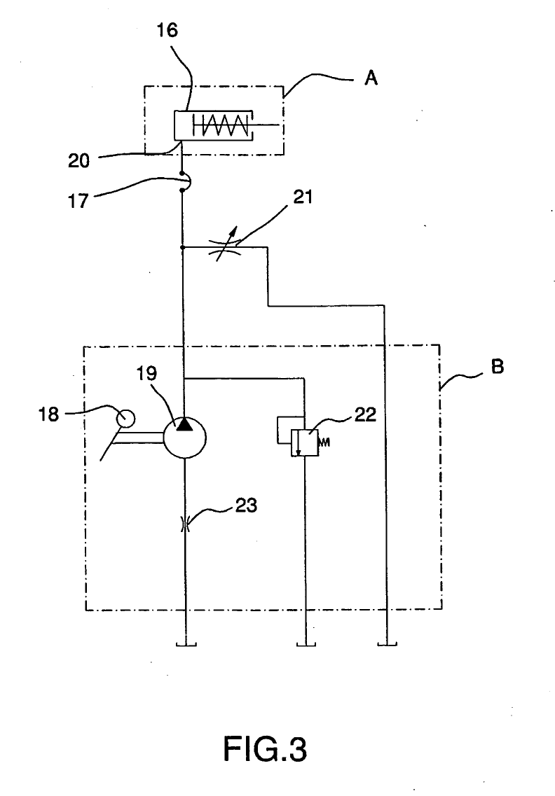

FIG. 3 shows a schematic wiring diagram of the emergency lowering device according to the invention.

FIG. 1 shows a lift cage 1 of the type that is commonly used on installations that demand transport of personnel and goods, for example on oil platforms at sea. The lift cage designated 1 is supported by a lattice tower 2 via a moving drive housing 3. This drive housing 3 is of a known type that in itself in a well known manner not shown here in detail is applied with rollers against longitudinal surfaces on the mast 2 and which via gear wheels 4 and 5 respectively is supported on a rack gear 6 running along the mast. The gear wheels 4, 5 are driven by electric motors 7 and 8 respectively shown only schematically in FIG. 1, so that the drive housing 3 and therefore the lift cage 1 can be driven up and down along the mast 2.

FIG. 2 shows the electric motor unit 7, 8 as two motors in parallel with each other, which are arranged to drive separate gear wheels denominated 4 and 5 respectively that are meshed with the rack gear 6 as described above. Position 9 implies a catching device, which in a known manner is used to prevent the lift cage from falling down. In a known manner, the catching device 9 can comprise a first and a second interacting brake element that can be engaged with each other if the lift cage 1 when descending exceeds a certain predetermined speed limit. The rack and pinion drive for the lift cage 1 along the mast 2 of the drive housing 3 like the catching device 9 can be of conventional type and therefore needs no further description.

As best illustrated in FIG. 2 each drive motor 7, 8 has on its free end a means of braking, designated 10 and 11 respectively, of mechanical type that in the event of a power cut is arranged to activate and stop the respective drive motor shaft from rotating and thereby also locking the gear wheels 4, 5 to the rack gear 6. The design of the motor brake 10, 11 can be of conventional type, with the application and release of the motor brake taking place linearly to the direction of the motor shaft in towards or away from the gear wheel respectively. Irrespective of their design, it should be understood that the engine brakes are activated automatically to lock the motor shaft in the absence of drive power.

The motor brakes 10, 11 each have a device that allows the mechanical release of the motor brake. This brake release device includes elements 12 and 13 respectively that can move linearly to the motor shaft and which elements are joined by means of a linkage system designated 14. The said linkage system 14 is so arranged that it can be set from the drive housing 3 by means of a control circuit comprising a means of actuation generally designated A in the form of a hydraulic piston and cylinder 16, which via a line 17 is in connection with a means of activation in the form of a pump 19 that is operated manually by a lever 18 for pumping hydraulic fluid from a tank (not shown). One end of the piston rod included in the piston and cylinder 16 is joined to the linkage system 14 in such a way that when the piston rod moves in the direction of the arrow offers simultaneous release of the said motor brakes 10, 11 respectively and when it moves in the opposite direction it allows simultaneous application of the brakes. As illustrated in FIGS. 1 and 2, the pump 19 can be suitably located on the roof of the lift cage 1 and as an alternative to the aforesaid lever 18 can be designed for operation by means of a foot pedal. In addition, it should be understood that the expression means of actuation as used herein should be interpreted as embracing all technically known means of setting and operating, both rotating and rectilinear. As non-limiting examples of means possessing similar effects can hereby also be named pneumatic cylinders and electric actuators, etc.

As illustrated in the schematic wiring diagram in FIG. 3, the pump 19 comprises a conventional pump with fixed displacement and direction of flow. The piston and cylinder arrangement 16 comprises a single action hydraulic cylinder with one port that acts both as an inlet and an outlet which is returned to its original position by means of a return spring arranged on the cylinder with draining through the said inlet/outlet.

The pump 19 forms part of a signal processing system generally designated B that in response to a periodically repeated measure, in this case referring to the operation of the pump handle and consequent activation of the means of actuation for performing a predetermined operating cycle. To enable this operating cycle to be performed, connected between the pump 19 and the piston and cylinder arrangement 16, or more exactly to its combined inlet/outlet, there are an adjustable restrictor 21 and a direct controlled overflow valve 22, both draining to the tank. Between the pump 19 and a tank from which the hydraulic fluid is taken there is arranged a non-adjustable restrictor 23, which limits the possible refilling rate of the pump. Using the flow through the adjustable restrictor 21, the time it takes for the operating movement of the means of actuation A within the operating cycle can be adapted to the downward acceleration of the lift cage 1 when the motor brakes are released so that the means of actuation has time to return to its original position before the lift cage has exceeded the predetermined speed limit.

The aforesaid expression a signal processing system B as it is used herein is regarded as embracing all technically known systems including a number of interlocking logical units with a controlling effect of the type that is sought after in the present invention. That is to say logical units that may be both electronic or electromechanical and pneumatic or hydraulic. For evacuating the passengers in a lift as fast as possible, it is essential that the descent of the lift cage can be controlled fully automatically, as people may act in panic in case of a genuine emergency situation. To avoid this is much as possible, the present invention uses a given operating cycle for lowering the lift cage whereby the components of the signal system are so chosen and interlinking that the lowering cycle can not be interrupted manually.

The system specified herein works in the following way:

When the power to the drive motors 7, 8 is absent and the motor brakes 10, 11 have consequently been applied, the lift cage 1 can be lowered by its own weight if a passenger, as a periodically repeated measure, by means of the pump 19, pressurises the piston and cylinder arrangement 16 so that, being driven by the brake release linkage system 14 in the direction of the arrow, it releases both motor brakes 10, 11. The drive motor 7, 8 shafts can consequently rotate again, whereby the lift cage 1 starts to slide down the mast 2 because of its own weight. The adjustable valve 21 is hereby so adjusted that there is a continuous leak from the piston and cylinder arrangement 16 whereby, through the action of the return spring, the pressure in the piston and cylinder arrangement is successively reduced until the piston and cylinder arrangement returns to its inactive bottom position. At this stage the mechanical brake release is inactive, whereby the motor shafts are stopped and consequently also the lift cage 1 by the electric motors' ordinary motor brakes.

Because the adjustable valve 21 leakage is so balanced that the brake release action ceases just before the lift cage 1 has reached the critical speed limit of the catching device 9, the lift cage can be pumped down by a passenger through a periodically repeated measure. The restrictor valve 23 between the inlet side of the pump 19 is adapted to the pump capacity and is used to prevent the pump from being refilled before the lift cage 1 has had time to stop. When building up an excessively high static pressure, draining will take place to tank via the direct controlled overflow valve 22. That is to say, both of these components 22, 23 prevent the passengers from building up an excessively high pressure by pumping in panic, which could activate the mechanical brake release for as long as is needed for the falling lift cage 1 to risk being caught by the catching device 9. Through calm and methodical pumping with brief pauses between each stroke of the pump, the lift cage can be safely moved down the mast, for example one metre between each pump stroke, until the passengers have reached a level from which they can be evacuated.

The present invention is not limited to the above description or as illustrated in the drawings but can be changed and modified in a number of different ways within the framework of the idea of invention specified in the following claims. In this respect, it should be understood that the present invention is applicable on all types of lift equipment having drive motors with locking brakes and catching devices. This is to say both traction lifts and hydraulic lifts. It should also be understood that the periodically repeated measure need not necessarily be performed manually as described above but can alternatively be performed directly by the signal processing system. More precisely, this is done as the signal processing system has a circuit for performing a series of measures as a response to one single activation by the passengers. For example, this could be achieved by a single press of an emergency lowering button whereby the lowering process is performed automatically as a series of measures carried out in succession.

1. Method of lowering a lift cage on a motorised lift that has a device for releasing motor brakes included in a drive motor an actuator operated from the lift cage that from its initial position can drive the brake release mechanism to an active brake release position and back to its initial position, and a catching device that stops the lift cage in case its descent should exceed a predetermined speed limit, wherein:
the actuator is arranged to respond to a periodically repeated measure by being moved in a previously defined operating cycle controlled by a signal processing system to an active brake releasing position and then back again to its initial position, and
the time it takes for the operating movement of the actuator within the operating cycle can be adapted to the downward acceleration of the lift cage when the motor brakes are released so that it has time to return to its original position before the lift cage has exceeded the predetermined speed limit.

2. Method according to claim 1, whereby the return of the actuator to its initial position is arranged to take place successively with a predetermined delay.

3. Method according to claim 1, whereby the periodically repeated measure is achieved automatically as a series of successive sequences when activated or is achieved manually via an actuator located in the lift cage or in conjunction with it.

4. Method according to claims claim 1, whereby for activating both the signal processing system and the means of actuator a compressed fluid is used in which maintaining an active brake releasing position for a predetermined period of time is done through continuous draining of the compressed fluid from the actuator.

5. Device for lowering a lift cage on a motorised lift that has a device for releasing motor brakes included in a drive motor an actuator operated from the lift cage that from its initial position can drive the brake release mechanism to an active brake release position and back to its initial position, and a catching device that stops the lift cage in case its descent should exceed a predetermined speed limit, wherein the device includes a signal processing system arranged in response to a periodically repeated measure to drive the actuator in a predetermined operating cycle to an active brake releasing position and then back to its initial position, whereby the signal processing system comprises a circuit for maintaining the active brake releasing position for a predetermined period of time.

6. Device according to claim 5, whereby the signal processing system maintaining circuit is designed to successively or after a certain delay return the actuator to its initial position.

7. Device according to claim 5, whereby both the signal processing system actuator comprise compressed fluid activated components.

8. Device according to claim 7, whereby the actuator comprises a single action hydraulic cylinder, the return stroke of which to its initial position is via a return spring.

9. Device according to claim 8, whereby the signal processing system comprises a pump controlled manually via a lever and a restrictor valve arranged in connection with it for draining or emptying the hydraulic cylinder in a certain period of time.

10. Device according to claim 9, whereby the restrictor valve can be adjusted to adapt the draining time of the hydraulic cylinder to the downward acceleration of the lift cage.
